(19) United States
(12) Patent Application Publication
(10) Pub. No.: US 2005/0243049 A1
(43) Pub. Date: Nov. 3, 2005

(54) Semiconductor integrated circuit device

(75) Inventor: Toshiaki Ueda, Ohtsu-Shi (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/118,483

(22) Filed: May 2, 2005

(30) Foreign Application Priority Data
Apr. 30, 2004 (JP) 2004-134940

(51) Int. Cl. G09G 3/36

(52) U.S. Cl. 345/98

(57) ABSTRACT

A semiconductor IC device includes a receiver having a bias circuit that applies a first bias potential to a first receiver for a clock signal and a second bias potential to each of a plurality of receivers for display data. The first bias potential is led out by first bias wiring, the second bias potential is led out by second bias wiring, and switches are connected between the second bias wiring 27 and respective ones the second receivers. The first bias potential is a steady bias potential, and the second bias potential is a high bias potential for a prescribed period of time from turn-on of the switches and becomes a steady bias potential after a prescribed period of time.

### FIELD OF THE INVENTION

This invention relates to a semiconductor integrated circuit device and, more particularly, to a semiconductor integrated circuit device the inputs to which are a clock signal and a data signal, which have the format of low-amplitude differential signals.

### BACKGROUND OF THE INVENTION

By virtue of such advantages as thinness, light weight and low power, liquid crystal display devices are used as dot-matrix-type display devices in equipment such as personal computers. In particular, active-matrix color liquid crystal display devices, which are advantageous in that image quality is controlled to a high definition, now dominate.

The liquid crystal display module of a liquid crystal display device includes a liquid crystal panel (LCD panel), a control circuit (referred to as a “controller” below) comprising a semiconductor integrated circuit device (referred to as an “IC” below), a scanning-side driver circuit (referred to as a “scan driver” below) comprising an IC, and a data-side driver circuit (referred to as a “data driver” below). In many cases a plurality of the data drivers are deployed. For example, if the resolution of the liquid crystal panel is XGA [1024×768 pixels, where one pixel comprises three dots of the colors R (red), G (green) and B (blue)] and 262,144 colors can be displayed (i.e., 64 gradations can be displayed for each of the colors R, G, B), then eight of the data drivers will be deployed, with display by 128 pixels being alloted to each single data driver.

A CMOS interface has long been in use in the transfer of signals between ICs in a liquid crystal display module. This interface serves as means for transmitting a binary voltage signal the amplitude of which varies between the power-supply voltage (the “H” level) and ground (the “L” level). As liquid crystal panels become larger in size and higher in definition, the number of pixels used in these panels increases. The market for SXGA (1280×1024 pixels) display devices and even UXGA (1600×1200 pixels), which are of high resolution than XGA devices, is growing. The clock frequency of the liquid crystal panel at present is 60 MHz with XGA. With SXGA and above, however, a higher clock frequency is used and high-speed transfer of the clock signal and display data, etc., is required between the controller and data drivers in the liquid crystal display module. With the conventional CMOS interface, however, a problem which arises is that parallel transfer must be adopted in order to prevent EMI (ElectroMagnetic Interference) noise, and this leads to an increase in the number of wiring traces.

A method of solving this problem is to use an interface that inputs the clock signal and display data to the data drivers in the form of low-amplitude differential signals. A data driver that employs such an interface has receivers for inputting the clock signal and display data in the form of low-amplitude differential signals. When a start signal is transferred and display data is loaded sequentially into the plurality, e.g., eight, of the data drivers in the liquid crystal display module, the start signal enters and a bias current flows into the receivers of each of the data drivers and the receivers are operated only in an interval up to completion of loading of the display data. In other intervals in which display data is not being loaded, the bias current at the receivers is cut off and the receiver operation halted in order to lower the consumed current (for example, see Japanese Patent Kokai Publication No. JP-A-11-249626).

[Patent Document 1]

Japanese Patent Kokai Publication No. JP-A-11-249626

### SUMMARY OF THE DISCLOSURE

When the operation of a receiver is halted in the data driver, a certain length of time is necessary for restoration of the steady operating state from the halted state. Further, in order to receive the input of the start signal and generate display-data load signal at the edge of the clock signal, it is necessary to bring the operation of the clock-signal receiver to a steady state before the operation of the display-data receiver. Therefore, in a case where there is not enough time for restoration of the steady state when input of the start signal is received and operation of the clock-signal receiver is restored at the same time as the display-data receiver, use is made of a method in which the operation of the clock-signal receiver is not halted even in an interval in which display data is not being loaded.

However, in a case where a bias potential is supplied from a bias circuit to the clock-signal and display-data receivers via common bias wiring in this method, a problem which arises is that the potential of the bias wiring fluctuates when the input of the start signal is received and the operation of the display-data receiver restored. If the speed of the clock signal is raised further at this time, there is the danger that the display data prevailing immediately after the start of loading of the display data will not be loaded normally.

Accordingly, there is need in the art for a semiconductor integrated circuit device in which the operation of a data receiver can be restored to the steady state at high speed without causing fluctuation of bias potential applied to a clock-signal receiver.

According to an aspect of the present invention, there is provided a semiconductor integrated circuit device comprising: a first receiver, to which a clock signal is input in the form of a low-amplitude differential signal, for converting the clock signal to a CMOS signal and outputting the CMOS signal; a plurality of second receivers, to which data is input in the form of a low-amplitude differential signal, for converting the data to CMOS signals and outputting the CMOS signals; a bias circuit for supplying bias potentials to the first receiver and second receivers to thereby operate the first receiver and second receivers; and a plurality of switches for changing over between supply and cut-off of the bias potential to each of the second receivers; wherein the bias circuit has a first bias potential output to the first receiver and a second bias potential output to each of the second receivers, the first bias potential output is led out by first bias wiring, the second bias potential output is led out by second bias wiring, the plurality of switches correspond to respective ones of the second receivers, and each switch is connected between the second bias wiring and a respective one of the second receivers.

The bias circuit in the semiconductor integrated circuit device includes a first bias potential generating circuit for outputting a steady bias potential as the first bias potential output to cause the first receiver to operate in a steady state; and a second bias potential generating circuit for outputting a high bias potential as the second bias potential output for a prescribed period of time from turn-on of the switches, and outputting a steady bias potential as the second bias potential output after a prescribed period of time to cause the second receivers to operate in a steady state.

The bias circuit in the semiconductor integrated circuit device includes a first bias potential generating circuit for outputting a steady bias potential as the first bias potential output to cause the first receiver to operate in a steady state; a second bias potential generating circuit for outputting a steady bias potential as the second bias potential output to cause the second receivers to operate in a steady state; and a precharging circuit for outputting a prescribed precharging voltage, as a high bias potential for a prescribed period of time from turn-on of the switches, as the second bias potential output.

The semiconductor integrated circuit device further comprises a capacitor connected between ground and a connection point at which the second bias wiring and each switch are connected, the bias circuit including a first bias potential generating circuit for outputting a steady bias potential as the first bias potential output to cause the first receiver to operate in a steady state, and a second bias potential generating circuit for outputting a steady bias potential as the second bias potential output to cause the second receivers to operate in a steady state.

The semiconductor integrated circuit device further comprises a circuit, which is connected to third bias wiring, for outputting a prescribed precharging voltage, as a high bias potential for a prescribed period of time from turn-on of the switches, as the second bias potential output, the bias circuit including a first bias potential generating circuit for outputting a steady bias potential as the first bias potential output to cause the first receiver to operate in a steady state, and a second bias potential generating circuit for outputting a steady bias potential as the second bias potential output to cause the second receivers to operate a steady state.

The semiconductor integrated circuit device is used as a data-side driver circuit of a display device.

The semiconductor integrated circuit device is used as a data-side driver circuit of a liquid crystal display device.

In accordance with the means described above, the supply of bias potentials is to separate bias wiring, namely the first bias wiring and the second bias wiring, at the clock-signal receiver and data receivers. As a result, the independence of the bias potentials can be maintained between the first and second bias wiring. Further, the bias wiring of the data receivers is subjected to a high bias potential for a prescribed period of time from turn-on of the switches, or is precharged to a prescribed potential, or has a capacitor connected between it and ground just in front of the bias-potential supply side of each switch. As a result, input of the start signal can be received and operation of the data receiver restored to the steady state at high speed.

The meritorious effects of the present invention are summarized as follows.

The present invention is such that in a semiconductor integrated circuit device in which data is loaded upon receipt of input of a start signal, the operation of a data receiver can be restored to the steady state at high speed without causing fluctuation of bias potential applied to a clock-signal receiver.

Other features and advantages of the invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the structure of a liquid crystal display module in which the semiconductor integrated circuit device of the present invention is used as a data driver;

FIG. 2 is a block diagram illustrating the structure of a data driver according to an embodiment of the present invention;

FIG. 3 is a circuit diagram illustrating a receiver according to a first embodiment used in the data driver shown in FIG. 2;

FIG. 4 is a circuit diagram illustrating a control signal generating circuit used in receivers shown in FIGS. 3, 7 and 14;

FIG. 5 is a circuit diagram illustrating a bias circuit used in a receiver shown in FIG. 3;

FIG. 6 is timing chart for describing operation of the receiver shown in FIG. 3;

FIG. 7 is a circuit diagram illustrating a receiver according to a second embodiment used in the data driver shown in FIG. 2;

FIG. 8 is a circuit diagram illustrating a bias circuit used in the receiver shown in FIG. 7;

FIG. 9 is timing chart for describing operation of the receiver shown in FIG. 7;

FIG. 10 is a circuit diagram illustrating a receiver according to a third embodiment used in the data driver shown in FIG. 2;

FIG. 11 is a circuit diagram illustrating a control signal generating circuit used in a receiver shown in FIG. 10;

FIG. 12 is a circuit diagram illustrating a bias circuit used in receivers shown in FIGS. 10 and 14;

FIG. 13 is timing chart for describing operation of the receiver shown in FIG. 10;

FIG. 14 is a circuit diagram illustrating a receiver according to a third embodiment used in the data driver shown in FIG. 2; and

FIG. 15 is timing chart for describing operation of the receiver shown in FIG. 14.

### PREFERRED EMBODIMENTS OF THE INVENTION

Preferred embodiments of the invention will now be described in detail with reference to the drawings.

Symbols used to identify display data and timing signals employed in the description below will be defined as follows in order to clarify CMOS signals and low-amplitude differential signals:
(1) Display data DA: CMOS signal
(2) Display data D00-D05, D10-D15, D20-D25: CMOS signal
(3) Display data DN/DP: low-amplitude differential signal
(4) Display data D00N/D00P-D02N/DO2P, D10N/D10P -D12N/D12P, D20N/D20P-D22N/D22P: low-amplitude differential signal
(5) Clock signal CK: CMOS signal
(6) Clock signal CKN/CKP: low-amplitude differential signal
(7) Start signal STH, latch signal STB: CMOS signal

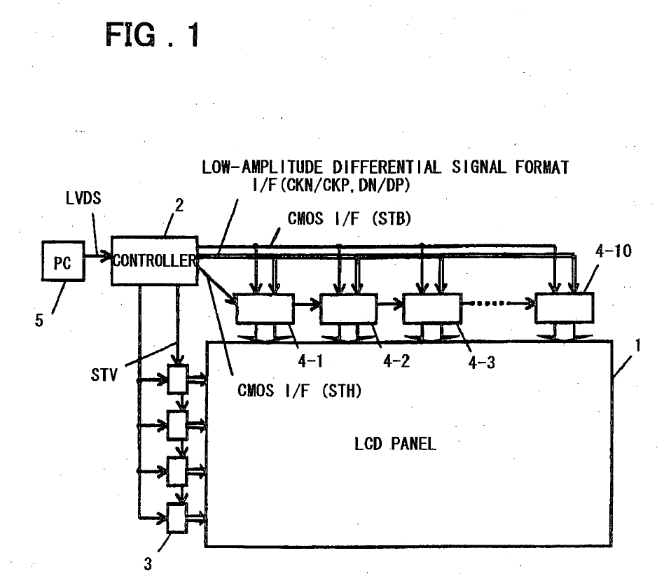

Reference will now be had to the drawings to describe a liquid crystal display device to which the semiconductor integrated circuit device of the present invention is applied as a data driver. The liquid crystal display module of the liquid crystal display device has a liquid crystal panel 1, a controller 2, scan drivers 3 and data drivers 4, as illustrated in FIG. 1. Although the details are not shown, if the liquid crystal panel 1 is of the transmitting type, it comprises a semiconductor substrate on which transparent pixel electrodes and thin-film transistors (TFTs) are disposed, an opposing substrate on which a single transparent electrode is formed over the entire surface thereof, and a liquid crystal sealed in the space between the two substrates. A prescribed voltage is applied to each of the pixel electrodes by controlling the TFTs, which have a switching function, and the transmissivity of the liquid crystal is changed depending upon the potential difference between each pixel electrode and the electrode of the opposing substrate, thereby displaying an image. It should be noted that the liquid crystal panel 1 may be of the reflecting type. In such case an image is displayed by providing the panel with a function that causes one of the two substrates to reflect light, and varying the reflectivity of the liquid crystal. Scanning lines for transmitting TFT switching control signals (scanning signals) and data lines for transmitting grayscale voltages to each of the pixel electrodes are wired on the semiconductor substrate. A case where the resolution of the liquid crystal panel 1 is SXGA [1280×1024 pixels, where one pixel comprises three dots of the colors R (red), G (green) and B (blue)] and 262,144 colors are displayed (i.e., 64 gradations can be displayed for each of the colors R, G, B) will be described as an example.

The scanning lines of the liquid crystal panel 1 are 1024 in number and are disposed in correspondence with respective ones of the 1024 pixels in the vertical direction. Since one pixel comprises the three R, G and B dots, 1280×3=3840 of the data lines are disposed in correspondence with the 1280 pixels in the horizontal direction. Four of the scanning drivers 3 are deployed, with each single scanning driver taking charge of 256 of the 1024 scanning lines. Ten of the data drivers 4 (4-1, 4-2, . . . ,4-10) are deployed, with each single data driver taking charge of 384 of the 3840 data lines.

Display data and timing signals are transferred to the controller 2 from a personal computer 5 via a LVDS (Low-Voltage Differential Signaling) interface, by way of example. Clock signals are transferred in parallel from the controller 2 to each of the scan drivers 3, a start signal STV for vertical synchronization is transferred from the controller 2 to the scan driver 3 of the first stage, and then the start signal STV is transferred sequentially from the controller 2 to the cascade-connected scan drivers 3 from the second stage onward. A latch signal STB, which comprises a CMOS signal, and a clock signal CKN/CKP and display data DN/DP, which comprise low-amplitude differential signals, are transferred in parallel from the controller 2 to each of the data drivers 4. A start signal STH for horizontal synchronization comprising a CMOS signal is transferred from the controller 2 to the data driver 4-1 of the first stage, and then the start signal STH is transferred sequentially from the controller 2 to the cascade-connected scan drivers 4-2, 4-3, . . . , 4-10 from the second stage onward. Examples of low-amplitude differential signals that can be applied are those that employ RSDS (Reduced Swing Differential Signaling: a registered trademark of National Semiconductor), min-LVDS (a registered trademark of Texas Instruments), or CMADS (Current Mode Advanced Differential Signaling: a registered trademark of NEC).

A pulse-shaped scanning signal is transmitted line-sequentially from the scanning drivers 3 to each of the scanning lines of the liquid crystal panel 1. All TFTs connected to a scanning line to which the pulse has been applied are turned on. At this time grayscale voltages are supplied from each data driver 4 to the data lines of the liquid crystal panel 1 and the voltages are applied to the pixel electrodes via the TFTs that have been turned on. When TFTs connected to a scanning line to which the pulse is no longer applied turn off, a potential difference between the pixel electrode and the electrode of the opposing substrate is held until the next grayscale voltage is applied to this pixel electrode. By applying pulses sequentially to all of the scanning lines, prescribed grayscale voltages are impressed upon all of the pixel electrodes. An image can be displayed by rewriting the grayscale voltages at the frame cycle.

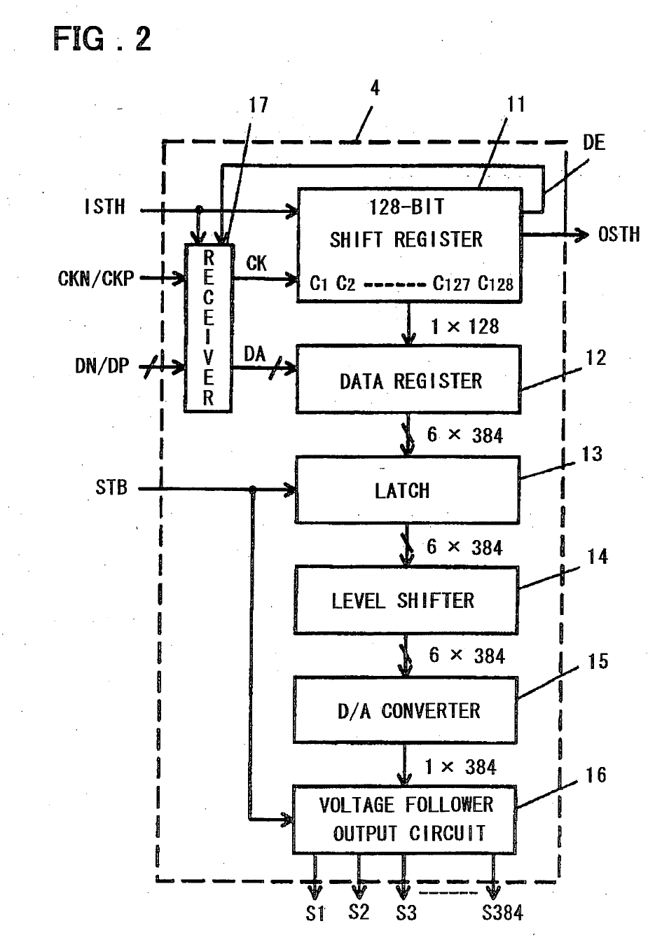

Reference will be had to FIG. 2 to describe the data driver 4 according to this embodiment. The data driver 4 is such that six bits of display data for each of R, G, B for displaying 64 gradations in each of R, G, B are input in correspondence with 384 data lines. The data driver 4 has 384 outputs, each of which delivers one grayscale voltage that conforms to the logic of the input display data. The data driver 4 includes a shift register 11, a data register 12, a latch 13, a level shifter 14, a digital-to-analog converting circuit (referred to as a “D/A converter” below) 15 and a voltage follower output circuit 16 as circuitry for subjecting digital display data DA to serial-to-parallel conversion and for further converting the data to an analog grayscale voltage that conforms to the logic of the display data DA. The data driver 4 further includes a receiver 17 as an interface circuit. The receiver 17 converts an input clock signal CKN/CKP and input display data DN/DP (D00N/D00P -D02N/D02P, D10N/D10P-D12N/D12P, D20N/D20P-D22N/D22P) having a bit width of 18 bits [grayscale display of 6 bits×3 dots of R, G, B (per pixel)=18] (the clock signal and display data are input as low-amplitude differential signals) to a clock signal CK and display data DA (D00-D05, D10-D15, D20-D25), which are CMOS signals. It should be noted that the data driver 4 has a power-supply circuit for operating each of the above-mentioned circuits, although the power-supply circuit is neither illustrated nor described.

The input and output terminals of the data driver 4 shown in FIG. 2 will now be described. An ISTH terminal is an input terminal for the start signal STH, which is input to the shift register 11. An OSTH terminal is an output terminal for the start signal STH, which is output from the shift register 11. An STB terminal is an input terminal for the latch signal STB, which is input to the latch 13 and voltage follower output circuit 16. A CKN/CKP terminal is an input terminal for the clock signal CKN/CKP, which is input to the receiver 17. A DN/DP terminal is an input terminal for the display data DN/DP, which is input to the receiver 17.

The shift register 11, data register 12, latch 13, level shifter 14, D/A converter 15 and voltage follower output circuit 16 will now be described. The shift register 11, which comprises 128 bits (three data lines R, G, B are allotted to one bit) in correspondence with 384 data lines, reads in the “H” level of the start signal STH at the timing of the edges of the clock signal CK every horizontal interval in which one scanning line is scanned among a plurality of scanning lines of the liquid crystal panel, generates data-loading control signals C1, C2, . . . , C128 successively, and supplies the control signals to the data register 12. Further, the shift register 11 delivers the start signal STH, which is applied to the data driver of the next stage, to the output terminal OSTH, and supplies a data-load complete signal DE to the receiver 17. At the timing of the trailing edges of the control signals C1, C2, . . . , C128 of the shift register 11, the data register 12 loads one scanning line of display data DA supplied by 18×128 bits [where bit width=6 bits×3 bits (R, G, B)], in correspondence with 384 data lines, every horizontal interval. The latch 13 latches the display data, which has been loaded into data register 12, every horizontal interval at the timing of the leading edges of the latch signal STB and supplies the data to the level shifter 14 in one batch. The display data DA from latch 13 is supplied to D/A converter 15 upon having its voltage level raised. Depending upon the display data from level shifter 14, one grayscale voltage that corresponds to the logic of the display data is supplied to the voltage follower output circuit 16 from among the 64 gray levels, this being performed for every item of 6-bit display data corresponding to each of the 384 display lines. The voltage follower output circuit 16 raises the driving capability of the grayscale voltage from the D/A converter 15 and outputs the voltage as outputs S1 to S384 at the timing of the trailing edges of latch signal STB.

The receiver 17 constructing the interface circuit will now be described. The receiver 17 receives the clock signal CKN/CKP and the display data DN/DP, which comprise low-amplitude differential signals, and outputs the clock signal CK and display data DA, which comprise CMOS signals, to the shift register 11 and data register 12, respectively.

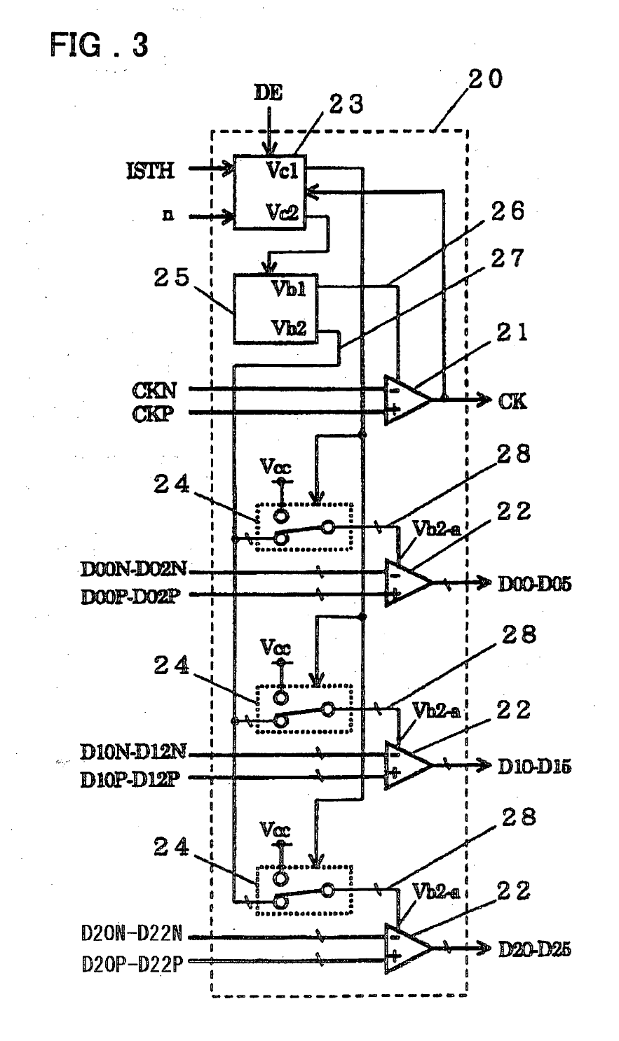

Reference will be had to FIGS. 3 to 6 to describe a receiver 20 of a first embodiment used as the receiver 17. As shown in FIG. 3, the receiver 20 includes a first receiver 21 for a clock signal; a plurality of second receivers 22 for display data; a control signal generating circuit 23 for generating control signals Vc1, Vc2; a plurality of switches 24 for changing over between supply and cut-off of the bias potential to the second receivers 22 depending upon the control signal Vc1; and a bias circuit 25 for supplying a first bias potential Vb1 to the first receiver 21 and a second bias potential Vb2 to the second receivers 22 to cause the first receiver 21 and second receivers 22 to operate. The first bias potential output Vb1 of the bias circuit 25 is led out by first bias wiring 26, and the second bias potential output Vb2 of the bias circuit 25 is led out by second bias wiring 27. The switches 24 correspond to respective ones of the second receivers 22, and the switches 24 are connected between the second bias wiring 27 and respective ones of the second receivers 22 via third bias wiring 28. In FIG. 3, one receiver 22 and one switch 24 are illustrated in correspondence with each of display data D00N/D00P to D02N/D02P of 6-bit width (=grayscale display of 6 bits×R1 dot), display data D10N/D10P to D12N/D12P of 6-bit width (=grayscale display of 6 bits×G1 dot) and display data D20N/D20P to D22N/D22P of 6-bit width (=grayscale display of 6 bits×B1 dot). However, three of each are provided in correspondence with display data of 6-bit width for R, G, B. For example, in case of display data D00N/D00P to D02N/DO2P for R, one receiver and one switch are provided in correspondence with each of D00N/D00P, D01N/D01P, D02N/D02P.

The first receiver 21 and each second receiver 22 has a comparator (not shown) that corresponds to a low-amplitude differential signal input that employs technology such as RSDS, min-LVDS or CMADS. The receiver 21 and receivers 22 are placed in the operating state by passing a bias current into a constant-current circuit that constructs the comparator. In order to pass a bias current into the constant-current circuit, a mirror circuit comprising a MOS transistor or a bi-polar transistor is constructed between the constant-current circuit and bias circuit 25. In this embodiment, it is assumed that the mirror circuit is constituted by a P-channel MOS transistor. Accordingly, in order to halt the operation of the second receiver 22, as will be described later, the gate potential of the P-channel MOS transistor of the mirror circuit, namely the bias potential of the second receiver 22, is made the power-supply potential Vcc to thereby cut off the bias current of the constant-current circuit. In the operating state, the first receiver 21, to which the clock signal CKN/CKP comprising a low-amplitude differential signal is input, outputs the clock signal CK comprising a CMOS signal. In the operating state, the second receivers 22, to which the display data DN/DP comprising a low-amplitude differential signal is input, output the display data DA comprising CMOS signals.

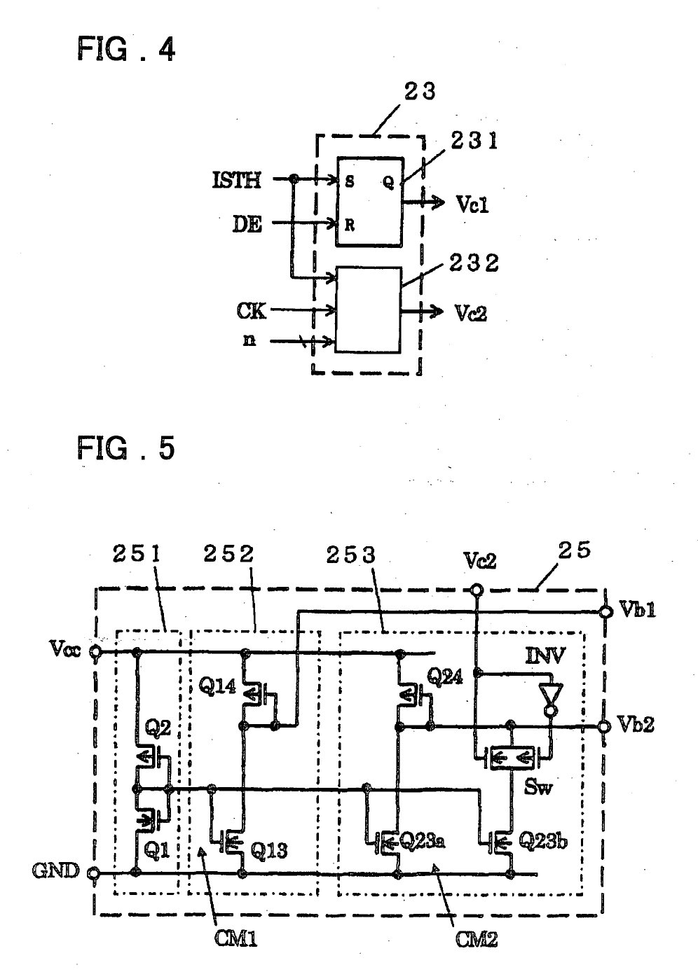

As shown in FIG. 4, the control signal generating circuit 23 has an RS latch 231 for generating the control signal Vc1 and a pulse-width adjusting circuit 232 for generating the control signal Vc2. When the start signal STH from the start-signal input terminal ISTH enters a set terminal S of the RS latch 231, an output terminal Q of the latch attains the “H” level. When the data-load complete signal DE from the shift register 11 enters a reset terminal R of the RS latch 231, the output terminal Q thereof assumes the “L” level. Accordingly, the control signal generating circuit 23 outputs an “H”-level signal as the control signal Vc1 from entry of the start signal STH to the data driver to loading of display data into the data driver. The pulse-width adjusting circuit 232, which is set to a desired n-bit count value, outputs the control signal Vc2 of a prescribed pulse width by counting the count value, using the clock signal CK, from the rising edge of the start signal STH from the start-signal input terminal ISTH.

As shown in FIG. 3, each switch 24 is controlled by the control signal Vc1 from the control signal generating circuit 23 in such a manner that when the control signal Vc1 is at the “H” level, the corresponding second receiver 22 is connected to the second bias wiring 27, and such that when the control signal Vc1 is at the “L” level, the corresponding second receiver 22 is connected to the power supply voltage Vcc.

As shown in FIG. 5, the bias circuit 25 has a bias current source 251, a first bias potential generating circuit 252 for generating the first bias potential Vb1, and a second bias potential generating circuit 253 for generating the second bias potential Vb2. The bias current source 251 has an N-channel MOS transistor Q1 of a diode connection and a P-channel MOS transistor Q2 of a diode connection the drains whereof are connected serially. The source of the MOS transistor Q2 is connected to a power supply terminal Vcc, and the source of the MOS transistor Q 1 is connected to a ground terminal GND.

The first bias potential generating circuit 252 is constructed as set forth below in order to output a steady bias voltage that is necessary to operate the first receiver 21 in the steady state. Specifically, the first bias potential generating circuit 252 includes an N-channel MOS transistor Q13 serving as an output-side transistor of a current mirror circuit CM1 in which the MOS transistors Q1, Q2 of the bias current source 251 serve as input-side transistors, and a P-channel MOS transistor Q14 of a diode connection serving as a load transistor connected to the current mirror circuit CM1, the drains of the transistors Q13 and Q14 being serially connected. The source of the MOS transistor Q13 is connected to the ground terminal GND, and the source of the MOS transistor Q14 is connected to the power supply terminal Vcc. The node of the serial connection between the MOS transistor Q13 and MOS transistor Q14 is connected to the first bias potential output terminal Vb1. The current mirror circuit is constructed by connecting the first bias potential output terminal Vb1 to the bias terminal of the first receiver 21 via the first bias wiring 26, adopting the MOS transistor Q14 as the input-side transistor, and adopting a P-channel MOS transistor, which is for passing a bias current into the first receiver 21, as the output-side transistor.

The second bias potential generating circuit 253 is controlled by the control signal Vc2 from the control signal generating circuit 23. When the control signal Vc2 is at the “L” level, the second bias potential generating circuit 253 outputs a steady bias potential necessary to operate the second receiver 22 in the steady state. When the control signal Vc2 is at the “H” level, the second bias potential generating circuit 253 outputs a high bias potential, which serves as a bias higher than the steady bias. In order to achieve this, the second bias potential generating circuit 253 includes parallel-connected N-channel MOS transistors Q23a and Q23b serving as output-side transistors constructing a second current mirror circuit CM2 in which the MOS transistors Q1, Q2 of the bias current source 251 serve as input-side transistors. A transfer gate Sw is serially connected to the MOS transistor Q23b. The second bias potential generating circuit 253 further includes a P-channel MOS transistor Q24 of a diode connection serving as a load transistor connected to the current mirror circuit CM2, the drain of the MOS transistor Q24 being connected on the drain side of the MOS transistors Q23a, Q23b of the parallel circuit. The sources of the MOS transistors Q23a, Q23b are connected to the ground terminal GND, and the source of the MOS transistor Q24 is connected to the power supply terminal VCC. A gate on the N-channel side of the transfer gate Sw and a gate on the P-channel side via an inverter INV are connected to the input terminal Vc2 in such a manner that the transfer gate Sw is capable of being turned on and off by the control signal Vc2 to the input terminal Vc2. The node of the serial connection between MOS transistors Q23a, Q23b and MOS transistor Q24 is connected to the second bias potential output terminal Vb2. The current mirror circuit is constructed by connecting the second bias potential Vb2 to the bias terminal of second receiver 22 via the second bias wiring 27, third bias wiring 28 and switch 24, and adopting the MOS transistor Q24 as the input-side transistor and a P-channel MOS transistor, which is for passing bias current into the second receiver 22, as the output-side transistor.

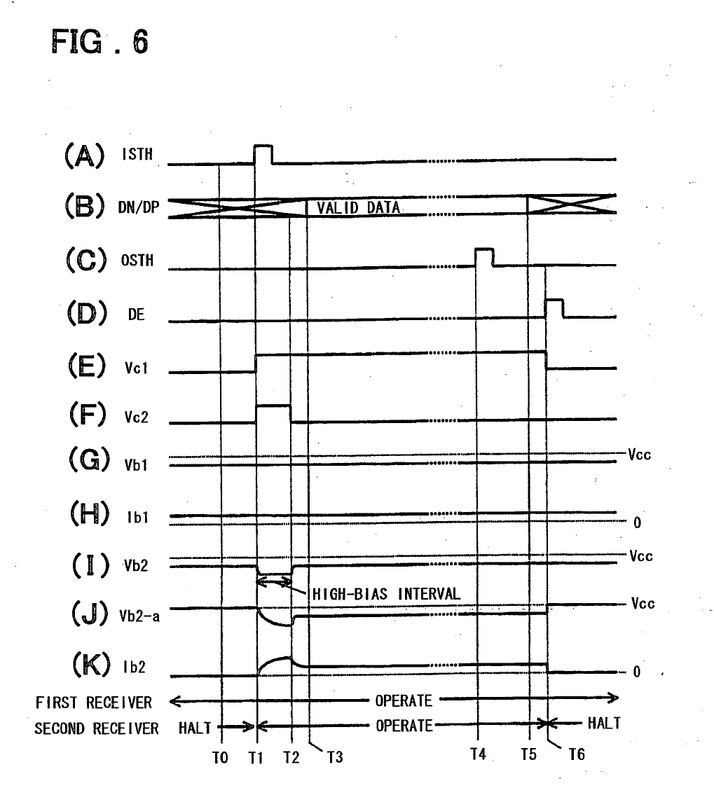

The operation of the receiver 20 is described with reference to FIG. 6, (A)-(K).

(1) The operation through which the first bias potential Vb1 is supplied to the first receiver 21 will be described. As indicated in FIG. 6(G), a steady bias potential necessary to operate the first receiver 21 in the steady state is constantly supplied as the bias current Vb1 from the first bias potential generating circuit 252 of the bias circuit 25 to the first receiver 21 via the first bias wiring 26. As indicated in FIG. 6(H), a steady bias current flows as the bias current Ib1 in the first receiver 21, and hence the first receiver 21 operates in the steady state at all times.

(2) The operation through which the second bias potential Vb2 is supplied to the second receivers 22 will be described. The start signal ISTH, data-load complete signal DE and control signals Vc1, Vc2 are at the “L” level at time T0. At this time the switches 24 are controlled by the “L” level of the control signal Vc1 so as to connect each second receiver 22 to the power supply terminal Vcc. As indicated in FIG. 6(J), a potential Vb2-a at the bias terminal of each second receiver 22 is the power supply potential Vcc (zero bias), and as indicated in FIG. 6(K), a bias current Ib2 does not flow into the second receivers 22 and, hence, the operation of the second receivers 22 is halted. Further, at this time the second bias potential generating circuit 253 of the bias circuit 25 is such that transfer gate Sw is turned off by the “L” level of the control signal Vc2 so that the second bias potential generating circuit 253 outputs a steady bias potential, which is necessary to operate the second receivers 22 in the steady state, as the second bias potential Vb2, as indicated of FIG. 6(I).

When the start signal ISTH attains the “H” level at time T1, as indicated in FIG. 6(A), the control signal Vc1 from the RS latch 231 of the control signal generating circuit 23 attains the “H” level, as indicated in FIG. 6(E), and the control signal Vc2 from the pulse-width adjusting circuit 232 of the control signal generating circuit 23 attains the “H” level, as indicated in FIG. 6(F). At this time the second bias potential generating circuit 253 of the bias circuit 25 is such that transfer gate Sw is turned on by the “H” level of the control signal Vc2 so that the second bias potential generating circuit 253 outputs a high bias potential, which is a bias higher than the steady bias, as the bias potential Vb2, as indicated of FIG. 6(I). Further, at this time the switches 24 are controlled by the “H” level of the control signal Vc1 in such a manner that the second receivers 22 are connected to the second bias wiring 27. As a result, the high bias potential Vb2 from the bias circuit 25 is supplied to the bias terminal of each second receiver 22 via the second bias wiring 27, third bias wiring 28 and switch 24. As indicated in FIG. 6(J), the potential Vb2-a of the bias terminal of each second receiver 22 starts undergoing a rapid transition from the power supply potential Vcc (zero bias) to the side of the high bias potential. As indicated in FIG. 6(K), the bias current Ib2 in each second receiver 22 starts flowing at a high bias and each second receiver 22 makes a transition to steady operation at high speed.

At time T2 upon elapse of a prescribed period of time from time T1, the control signal Vc2 from the pulse-width adjusting circuit 232 of the control signal generating circuit 23 reverts to the “L” level, as indicated in FIG. 6(F). At this time, the second bias potential generating circuit 253 of the bias circuit 25 is such that transfer gate Sw is turned off by the “L” level of the control signal Vc2 so that the steady bias potential generating circuit 253 outputs a steady bias potential as the bias potential Vb2, as indicated in FIG. 6(I). As a result, the steady bias potential Vb2 from the bias circuit 25 is supplied to the bias terminal of each second receiver 22 via the second bias wiring 27, third bias wiring 28 and switch 24. As indicated in FIG. 6(J), the potential Vb2-a at the bias terminal of the second receiver 22 becomes a steady bias potential. As indicated in FIG. 6(K), the bias current Ib2 that causes the second receivers 22 to operate in the steady state flows in the second receivers 22 and therefore operation of the second receivers 22 is maintained in the steady state.

At time T3 upon elapse of a prescribed period of time from time T2, valid data of the display data DN/DP starts entering the second receivers 22, as indicated in FIG. 6(B). At time T4, the start signal OSTH attains the “H” level, as indicated in FIG. 6(C). At time T5 upon elapse of a prescribed period of time from time T4, entry of the valid data of the display data DN/DP to the second receiver 22 is completed, as indicated in FIG. 6(B). At time T6 upon elapse of a prescribed period of time from time T5, the data-load complete signal DE attains the “H” level, as indicated of FIG. 6(D), whereupon the control signal Vc1 from the RS latch 231 of the control signal generating circuit 23 reverts to the “L” level, as indicated in FIG. 6(E). At this time the switches 24 are controlled by “L” level of the control signal Vc1 in such a manner that the second receivers 22 are connected to the power supply voltage Vcc. As indicated in FIG. 6(J), the potential Vb2-a at the bias terminal of each second receiver 22 becomes the power supply potential Vcc (zero bias). As indicated in FIG. 6(K), the bias current Ib2 no longer flows into the second receivers 22 and the operation of the second receivers 22 halts.

As described above, the supply of the bias potential Vb1 to the first receiver 21 in the receiver 20 is performed from the first bias potential generating circuit 252 via the first bias wiring 26, whereby the second bias potential generating circuit 253 and the second bias wiring 27 that supply the bias potential Vb2 to the second receivers 22 become a separate channel. As a result, it can be so arranged that when the bias potential Vb2 is supplied to the second receivers 22 in order to place the second receivers 22 in the operating state from the state in which operation is halted, the supply of the bias potential Vb2 to the second receivers 22 is implemented without the supply of the bias current Vb1 to the first receiver 21 being affected. Further, it is so arranged that when the bias potential Vb2 is supplied to the second receivers 22 in order to place the second receivers 22 in the operating state from the state in which operation is halted, the bias potential Vb2 is supplied at a high bias for a prescribed period of time by the second bias potential generating circuit 253. The potential Vb2-a at the bias terminal of each second receiver 22 via the second bias wiring 27, therefore, makes a rapid transition from the power supply potential Vcc (zero bias) to the side of the high-bias potential and the second receivers 22 attain the steady state rapidly.

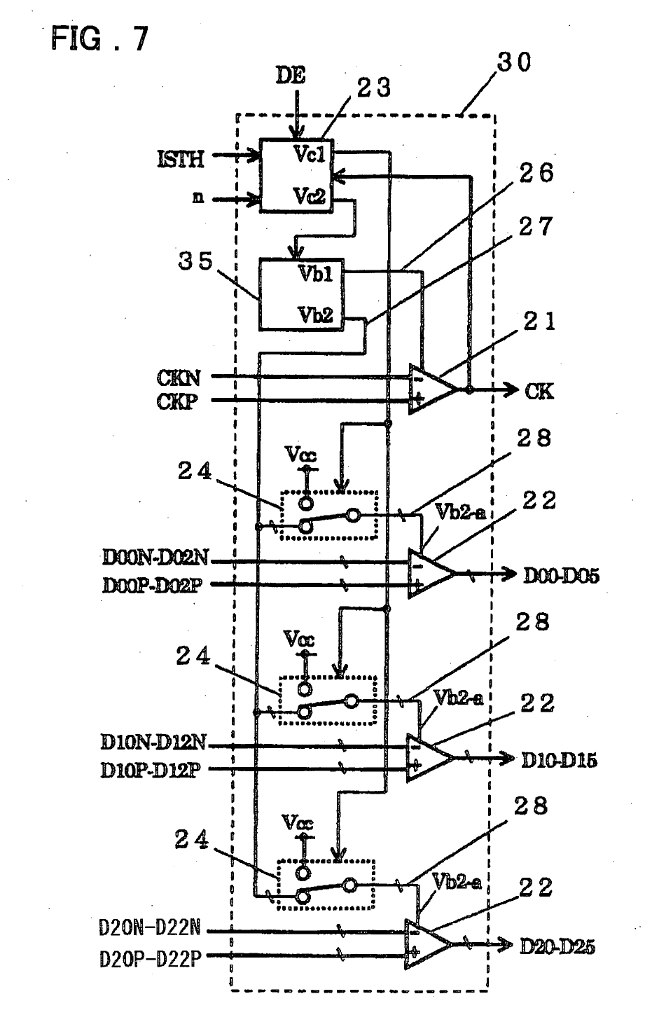

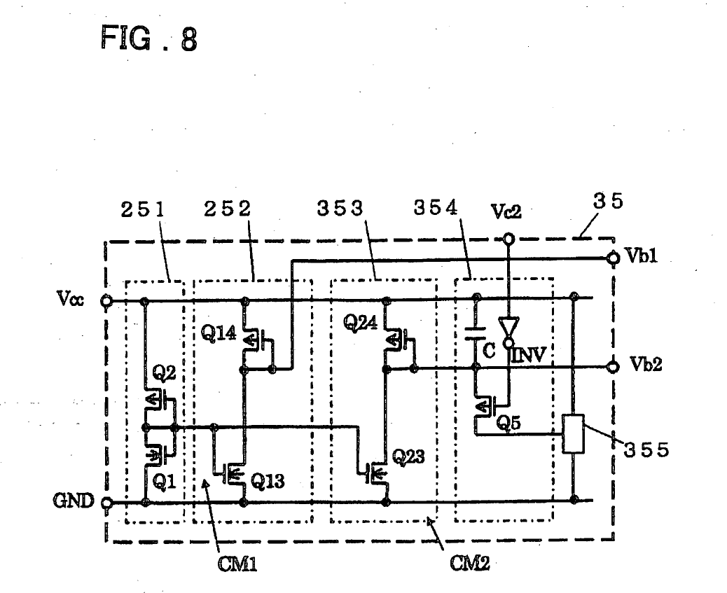

A receiver 30 according to a second embodiment used as the receiver 17 will be described next with reference to FIGS. 7 to 9. Components identical with those of the receiver 20 shown in FIG. 3 are designated by like reference characters and need not be described again. The receiver 30 in FIG. 7 differs from the receiver 20 of FIG. 3 in that the receiver 30 has a bias circuit 35 instead of the bias circuit 25. Further, the bias circuit 35 differs from the bias circuit 25 in that it has a second bias potential generating circuit 353 instead of the second bias potential generating circuit 253 and further includes a precharging circuit 354 and precharging power supply 355, as shown in FIG. 8.

The second bias potential generating circuit 353 has a circuit structure, which is similar to that of the first bias potential generating circuit 252, constituted by MOS transistors Q23, Q24 instead of the MOS transistors Q13, Q14 of the first bias potential generating circuit 252 in order to output a steady bias potential necessary to operate the second receivers 22 in the steady state. The node of the serial connection between the MOS transistors Q23 and Q24 is connected to the second bias potential output terminal Vb2. The current mirror circuit is constructed by connecting the second bias potential output terminal Vb2 to the bias terminal of the second receiver 22 via the second bias wiring 27, third bias wiring 28 and switch 24, adopting the MOS transistor Q24 as the input-side transistor, and adopting a P-channel MOS transistor, which is for passing a bias current into the second receivers 22, as the output-side transistor.

The precharging circuit 354 has a precharging capacitor C, which is connected between the power supply terminal Vcc and the node of the serial connection between the MOS transistors Q23 and Q24, and a P-channel MOS transistor Q5 for supplying a precharging voltage Vp from the precharging power supply 355 to the capacitor C. The precharging circuit 354 is controlled by supplying the control signal Vc2 from the control signal generating circuit 23 to the gate of the MOS transistor Q5 via the inverter INV. When the control signal Vc2 is at the “H” level, the MOS transistor Q5 is turned on and the precharging voltage Vp from the precharging power supply 355 is output to the second bias potential output terminal Vb2 as a high bias potential.

The precharging power supply 355 can output the precharging voltage Vp as a predetermined fixed voltage or upon being adjusted to a desired voltage by a control signal (not shown).

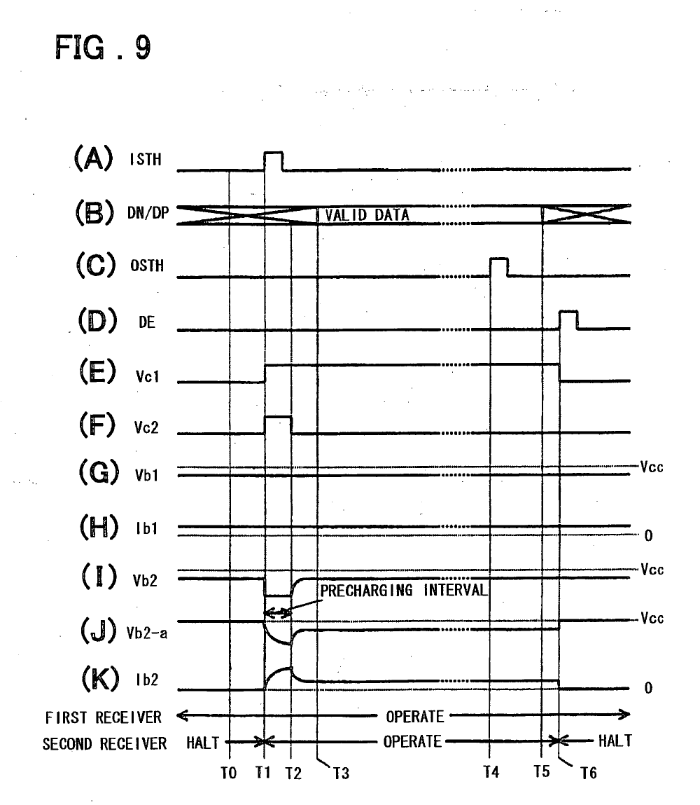

The operation of the receiver 30 will now be described with reference to FIG. 9, (A)-(K).

(1) The operation through which the bias potential Vb1 is supplied to the first receiver 21 is similar to that of the receiver 20 and need not be described again.

(2) The operation through which the bias potential Vb2 is supplied to the second receivers 22 will be described. The start signal ISTH, data-load complete signal DE and control signals Vc1, Vc2 are at the “L” level at time T0 in a manner similar to that of the receiver 20. At this time the switches 24 are controlled so as to connect the second receivers 22 to the power supply voltage Vcc in a manner similar to that of the receiver 20. As indicated in FIG. 9(J), the potential Vb2-a at the bias terminal of each second receiver 22 is the power supply potential Vcc (zero bias), and as indicated in FIG. 9(K), a bias current Ib2 does not flow into the second receivers 22 and, hence, the operation of the second receivers 22 is halted. Further, at this time the precharging circuit 354 of the bias circuit 35 is such that MOS transistor Q5 is turned off by the “L” level of the control signal Vc2 so that the second bias potential generating circuit 353 outputs a steady bias potential, which is necessary to operate the second receivers 22 in the steady state, as the bias potential Vb2, as indicated of FIG. 9(I).

When the start signal ISTH attains the “H” level at time T1, as indicated in FIG. 9(A), the control signal Vc1 attains the “H” level, as indicated in FIG. 9(E), and the control signal Vc2 attains the “H” level, as indicated in FIG. 9(F), in a manner similar to that of the receiver 20. At this time the precharging circuit 354 of the bias circuit 35 is such that the MOS transistor Q5 is turned on by the “H” level of the control signal Vc2. As a result, the capacitor C of the precharging circuit 354 is charged at a potential difference Vcc-Vp by the precharging voltage Vp from the precharging power supply 355, and a high bias potential the bias of which is higher than the steady bias is output as the bias potential Vb2, as indicated of FIG. 9(I). At this time, in a manner similar to that of the receiver 20, a high bias potential from the bias circuit 35 is supplied to the bias terminal of each second receiver 22 and each second receiver 22 makes a transition to steady operation at high speed.

At time T2 upon elapse of a prescribed period of time from time T1, the control signal Vc2 reverts to the “L” level, as indicated in FIG. 9(F), in a manner similar to that of receiver 20. At this time, the precharging circuit 354 of the bias circuit 35 is such that MOS transistor Q5 is turned off by the “L” level of the control signal Vc2 so that the second bias potential generating circuit 353 outputs a steady bias potential as the bias potential Vb2, as indicated in FIG. 9(I). As a result, the steady bias potential from the bias circuit 35 is supplied to the bias terminal of each second receiver 22 and the operation of each second receiver 22 is maintained in the steady state in a manner similar to that of receiver 20.

Operation from time T2 to time T6 is similar to that of the receiver 20. At time T6, the potential Vb2-a at the bias terminal of each second receiver 22 becomes the power supply potential Vcc (zero bias), as indicated in FIG. 9(J), in a manner similar to that of the receiver 20. As indicated in FIG. 9(K), the bias current Ib2 no longer flows into the second receivers 22 and the operation of the second receivers 22 halts.

As described above, it can be so arranged that when the bias potential Vb2 is supplied to the second receivers 22 in the receiver 30 in order to place the second receivers 22 in the operating state from the state in which operation is halted, the supply of the bias potential Vb2 to the second receivers 22 is implemented without the supply of the bias current Vb1 to the first receiver 21 being affected, in a manner similar to that of the receiver 20. Further, it is so arranged that when the bias potential Vb2 is supplied to the second receivers 22 in order to place the second receivers 22 in the operating state from the state in which operation is halted, the bias potential Vb2 is supplied at a high bias for a prescribed period of time by the precharging circuit 354. The second receiver 22 therefore attains the steady state rapidly as in the case of the receiver 20.

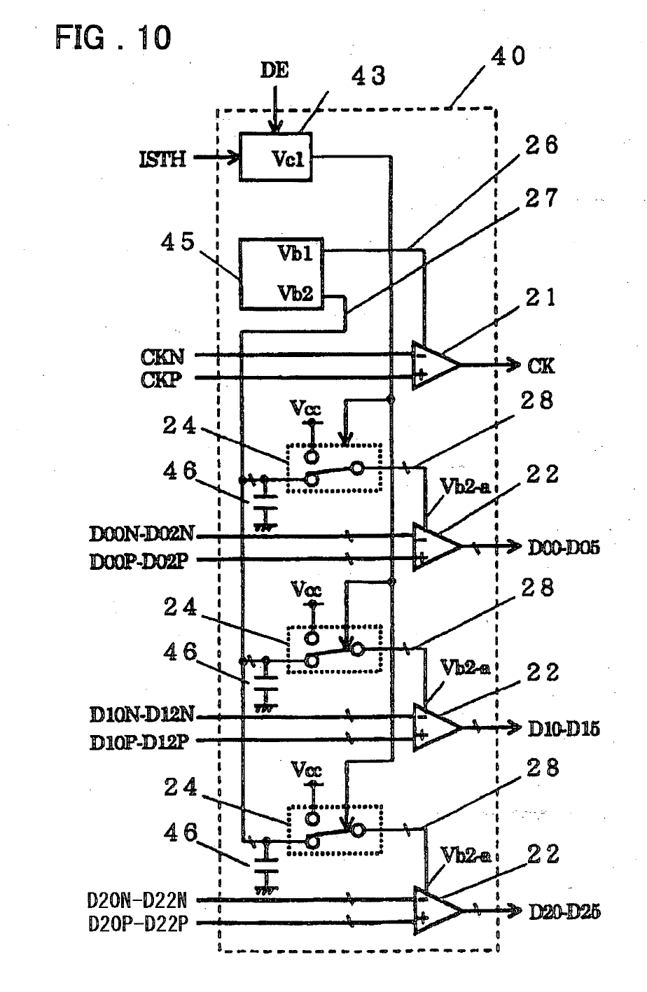

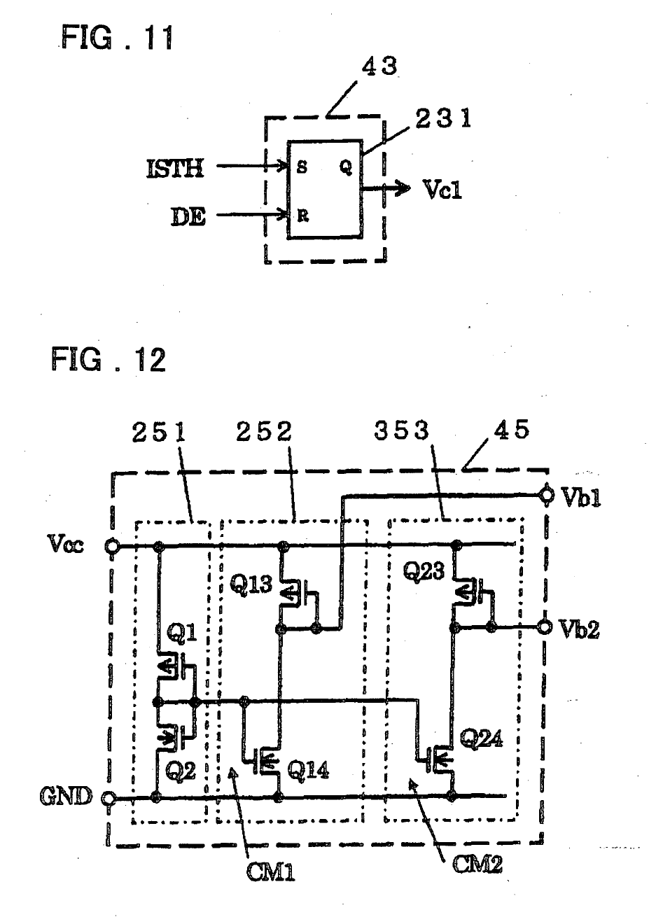

A receiver 40 according to a third embodiment used as the receiver 17 will be described next with reference to FIGS. 10 to 13. Components identical with those of the receivers 20 and 30 shown in FIGS. 3 and 7 are designated by like reference characters and need not be described again. The receiver 40 in FIG. 10 differs from the receiver 20 of FIG. 3 in that the receiver 40 has a control signal generating circuit 43 instead of the control signal generating circuit 23 and a bias circuit 45 instead of the bias circuit 25, and in that a capacitor 46 is connected between ground and the node of the connection between the second bias wiring 27 and each switch 24. The control signal generating circuit 43 differs from the control signal generating circuit 23 in that it does not have the pulse-width adjusting circuit 232, as illustrated in FIG. 11. Further, the bias circuit 45 differs from the bias circuit 25 in that it has the second bias potential generating circuit 353, which is used in the bias circuit 35 of the receiver 30, instead of the second bias potential generating circuit 253, as illustrated in FIG. 12.

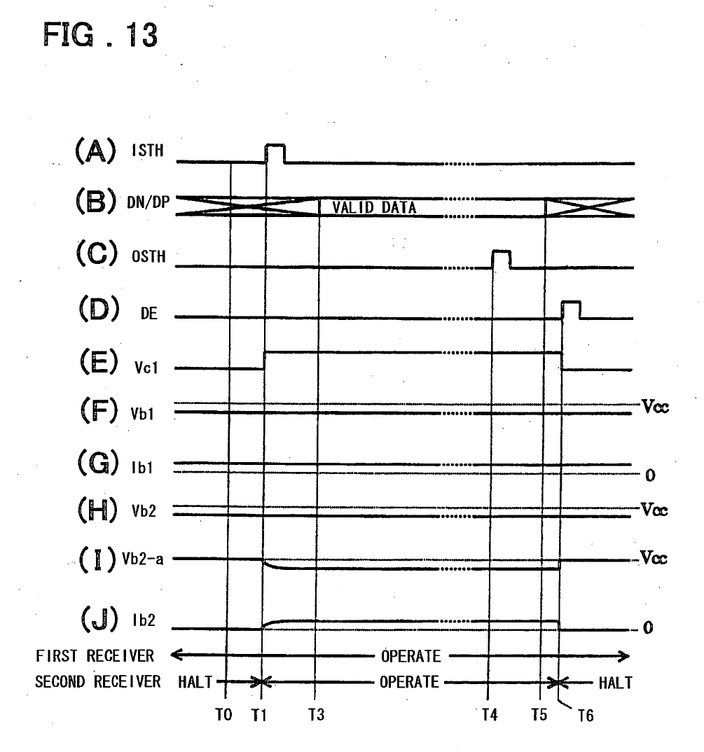

The operation of the receiver 40 will now be described with reference to FIG. 13, (A)-(J).

(1) The operation through which the first bias potential Vb1 is supplied to the first receiver 21 is similar to that of the receiver 20 and need not be described again.

(2) The operation through which the bias potential Vb2 is supplied to the second receivers 22 will be described. The start signal ISTH, data-load complete signal DE and control signals Vc1 are at the “L” level at time T0. At this time the switches 24 are controlled so as to connect the second receivers 22 to the power supply terminal Vcc in a manner similar to that of the receiver 20. As indicated in FIG. 13(I), the potential Vb2-a at the bias terminal of the second receiver 22 is the power supply potential Vcc (zero bias), and as indicated in FIG. 13(J), a bias current Ib2 does not flow into the second receivers 22 and, hence, the operation of the second receivers 22 is halted. Further, at this time second bias potential generating circuit 353 of the bias circuit 45 outputs a steady bias potential, which is necessary to operate the second receivers 22 in the steady state, as the bias potential Vb2, as indicated in FIG. 13(H). The steady bias potential from the second bias potential generating circuit 353 charges each capacitor 46 via the second bias wiring 27.

When the start signal ISTH attains the “H” level at time T1, as indicated in FIG. 13(A), the control signal Vc1 from the RS latch 231 of the control signal generating circuit 43 attains the “H” level, as indicated in FIG. 13(E). At this time the switches 24 are controlled so as to connect the second receivers 22 to the second bias wiring 27 in a manner similar to that of the receiver 20. As a result, the voltage that has been charged in the capacitor 46 by the steady bias potential from the second bias potential generating circuit 353 of the bias circuit 45 is supplied to the bias terminal of each second receiver 22 via the third bias wiring 28 and corresponding switch 24. Since the third bias wiring 28 is sufficiently shorter than the second bias wiring 27, the potential Vb2-a of the bias terminal of each second receiver 22 starts making a rapid transition from the power supply potential Vcc (zero bias) to the side of the steady bias potential Vb2. In addition, as indicated of FIG. 13(J), the bias current Ib2 in the second receivers 22 also begins flowing rapidly as a steady bias and the second receivers 22 shift rapidly to steady operation.

At time T3 upon elapse of a prescribed period of time from time T1, valid data of the display data DN/DP starts entering the second receiver 22, as indicated in FIG. 13(B). Operation from time T3 to time T6 is similar to that of the receiver 20. At time T6, the potential Vb2-a at the bias terminal of the second receiver 22 becomes the power supply potential Vcc (zero bias), as indicated in FIG. 13(J), in a manner similar to that of the receiver 20. As indicated in FIG. 13(J), the bias current Ib2 no longer flows into the second receivers 22 and the operation of the second receivers 22 halts.

As described above, it can be so arranged that when the bias potential Vb2 is supplied to the second receivers 22 in the receiver 40 in order to place the second receivers 22 in the operating state from the state in which operation is halted, the supply of the bias potential Vb2 to the second receivers 22 is implemented without the supply of the bias current Vb1 to the first receiver 21 being affected, in a manner similar to that of the receiver 40. Further, it is so arranged that when the bias potential Vb2 is supplied to the second receivers 22 in order to place the second receivers 22 in the operating state from the state in which operation is halted, the voltages of the capacitors 46 that have been charged by the steady bias potential Vb2 from the second bias potential generating circuit 353 are used. The bias wiring that supplies the bias potential Vb2 can be shortened and the second receivers 22 attain the steady state rapidly.

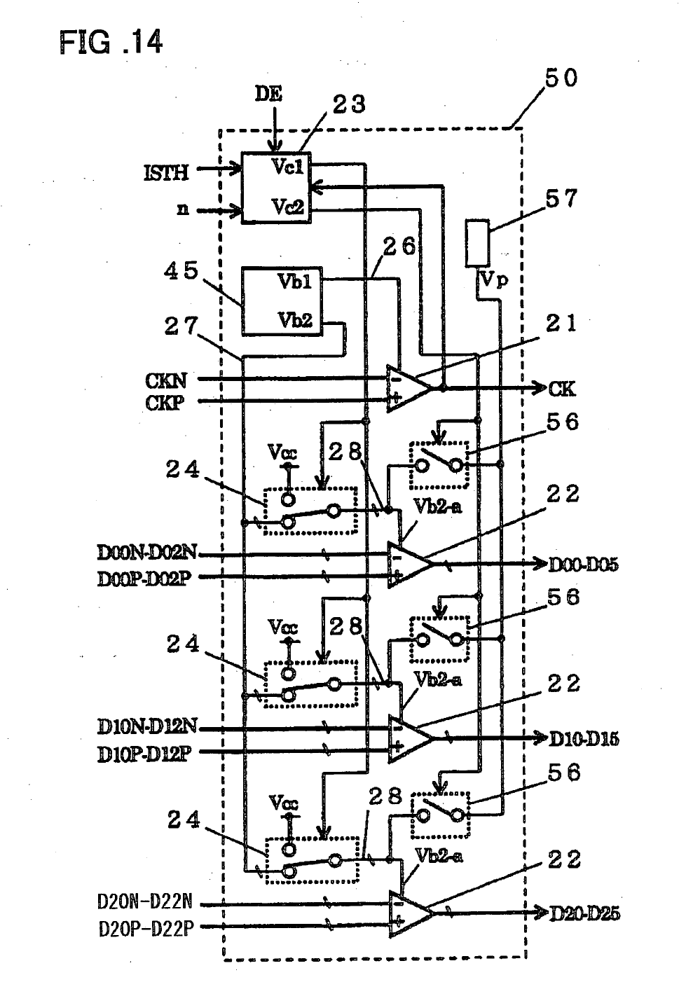

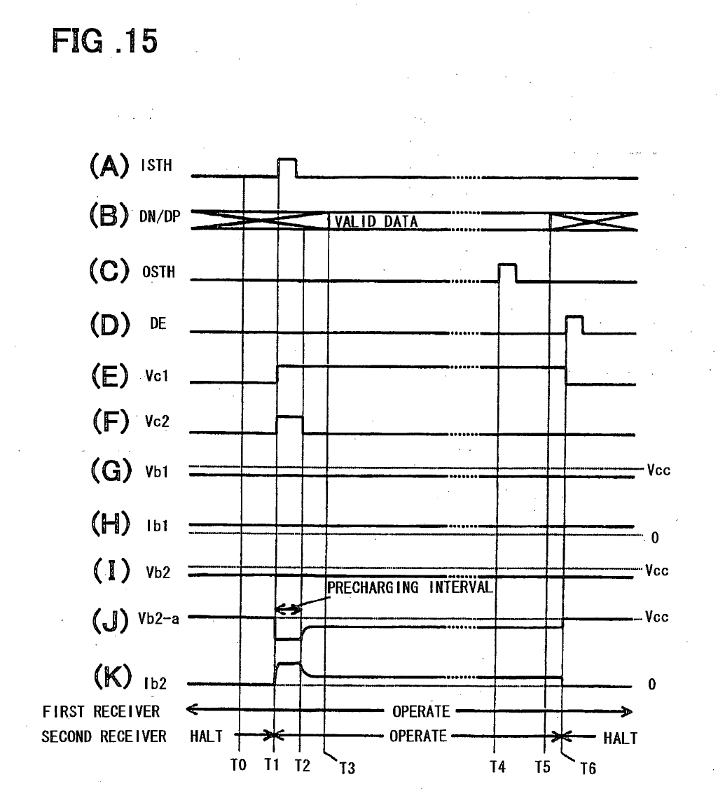

A receiver 50 according to a fourth embodiment used as the receiver 17 will be described next with reference to FIGS. 14 and 15. Components identical with those of the receivers 20, 30 and 40 shown in FIGS. 3, 7 and 10 are designated by like reference characters and need not be described again. The receiver 50 in FIG. 14 differs from the receiver 20 of FIG. 3 in that the receiver 50 has the bias circuit 45, which is used in the receiver 40, instead of the bias circuit 25, and in that a precharging power supply 57 is connected to the third bias wiring 28 via switches 56. It should be noted that although the points at which the switches 56 and third bias wiring 28 are connected lie between the switches 24 and the second receivers 22, the connection points may be placed between the second bias wiring 27 and the switches 24.

The switches 56 are controlled by the control signal Vc2 from the control signal generating circuit 23 as shown in FIG. 14. Specifically, the switches are turned on so as to connect the second receivers 22 to the precharging power supply 57 when the control signal Vc2 is at the “H” level, and are turned off when the control signal Vc2 is at the “L” level.

The precharging power supply 57 can output the precharging voltage Vp as a predetermined fixed voltage or upon being adjusted to a desired voltage by a control signal (not shown).

The operation of the receiver 50 will now be described with reference to FIG. 15, (A)-(K).

(1) The operation through which the bias potential Vb1 is supplied to the first receiver 21 is similar to that of the receiver 20 and need not be described again.

(2) The operation through which the bias potential Vb2 is supplied to the second receivers 22 will be described. The start signal ISTH, data-load complete signal DE and control signals Vc1, Vc2 are at the “L” level at time T0 in a manner similar to that of the receiver 20. At this time the switches 24 are controlled so as to connect the second receivers 22 to the power supply voltage Vcc in a manner similar to that of the receiver 20. As indicated in FIG. 15(J), the potential Vb2-a at the bias terminal of each second receiver 22 is the power supply potential Vcc (zero bias), and as indicated in FIG. 15(K), a bias current Ib2 does not flow into the second receivers 22 and, hence, the operation of the second receivers 22 is halted. Further, at this time the bias circuit 45 outputs a steady bias potential, which is necessary to operate the second receivers 22 in the steady state, as the bias potential Vb2, as indicated of FIG. 15(I). The switches 56 are turned off by the “L” level of the control signal Vc2.

When the start signal ISTH attains the “H” level at time T1, as indicated in FIG. 15(A), the control signal Vc1 attains the “H” level, as indicated in FIG. 15(E), and the control signal Vc2 attains the “H” level, as indicated in FIG. 15(F), in a manner similar to that of the receiver 20. At this time the switches 24 are turned on by the “H” level of the control signal Vc1, and the switches 56 are turned on by the “H” level of the control signal Vc2. As a result, at this time the bias circuit 45 is outputting a steady bias current as the bias potential Vb2, as indicated of FIG. 15(I). However, the precharging voltage Vp from the precharging power supply 57 is supplied to the bias terminal of each second receiver 22 and, as indicated of FIG. 15(J), the potential Vb2-a of the bias terminal of each second receiver 22 starts making a rapid transition from the power supply potential Vcc (zero bias) to the side of the high bias potential. In addition, as indicated in FIG. 15(K), the bias current Ib2 in the second receiver 22 starts flowing at a high bias and the second receivers 22 make a transition to steady operation at high speed.

At time T2 upon elapse of a prescribed period of time from time T1, the control signal Vc2 from the control signal generating circuit 23 reverts to the “L” level, as indicated in FIG. 15(F), in a manner similar to that of receiver 20. At this time, the switches 56 are turned off by the “L” level of the control signal Vc2 and a steady bias potential from the bias circuit 45 is supplied to the bias terminal of each second receiver 22 as the bias potential Vb2. As indicated in FIG. 15(J), the potential Vb2-a at the bias terminal of each second receiver 22 changes from the high bias potential to the steady bias potential and the operation of the second receivers 22 is maintained in the steady state.

Operation from time T2 to time T6 is similar to that of the receiver 20. At time T6, the potential Vb2-a at the bias terminal of the second receiver 22 becomes the power supply potential Vcc (zero bias), as indicated in FIG. 15(J), in a manner similar to that of the receiver 20. As indicated in FIG. 15(K), the bias current Ib2 no longer flows into the second receivers 22 and the operation of the second receivers 22 halts.

As described above, it can be so arranged that when the bias potential Vb2 is supplied to the second receivers 22 in the receiver 50 in order to place the second receivers 22 in the operating state from the state in which operation is halted, the supply of the bias potential Vb2 to the second receivers 22 is implemented without the supply of the bias current Vb1 to the first receiver 21 being affected, in a manner similar to that of the receiver 20. Further, it is so arranged that when the bias potential Vb2 is supplied to the second receivers 22 in order to place the second receivers 22 in the operating state from the state in which operation is halted, the bias potential Vb2 is supplied at a high bias for a prescribed period of time by the precharging circuit 57. The second receiver 22 therefore attains the steady state rapidly as in the case of the receiver 20.

A liquid crystal display device has been described as an example in the embodiments above. However, the present invention is not limited to a liquid crystal display device and can also be applied to other display devices. Furthermore, the invention is not limited to display devices and can also be used in other electronic devices in which data is loaded.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. A semiconductor integrated circuit device comprising:
a first receiver, to which a clock signal is input in the form of a low-amplitude differential signal, for converting the clock signal to a CMOS signal and outputting the CMOS signal;
a plurality of second receivers, to which data is input in the form of low-amplitude differential signals, for converting the data to CMOS signals and outputting the CMOS signals;
a bias circuit for supplying bias potentials to said first receiver and to said second receivers to thereby operate said first receiver and said second receivers; and
a plurality of switches for changing over between supply and cut-off of the bias potential to each of said second receivers;
wherein said bias circuit has a first bias potential output to said first receiver and a second bias potential output to each of said second receivers,
the first bias potential output is led out by first bias wiring,
the second bias potential output is led out by second bias wiring, said plurality of switches correspond to respective ones of said second receivers, and
each switch is connected between the second bias wiring and a respective one of said second receivers by third bias wiring.

2. The device according to claim 1, wherein said bias circuit comprises:
a first bias potential generating circuit for outputting a steady bias potential as the first bias potential output to cause said first receiver to operate in a steady state; and
a second bias potential generating circuit for outputting a high bias potential as the second bias potential output for a prescribed period of time from turn-on of said switches, and outputting a steady bias potential as the second bias potential output after said prescribed period of time to cause said second receivers to operate in a steady state.

3. The device according to claim 1, wherein said bias circuit comprises:
a first bias potential generating circuit for outputting a steady bias potential as the first bias potential output to cause said first receiver to operate in a steady state;
a second bias potential generating circuit for outputting a steady bias potential as the second bias potential output to cause said second receivers to operate in a steady state; and
a precharging circuit for outputting a prescribed precharging voltage, as a high bias potential for a prescribed period of time from turn-on of said switches, as the second bias potential output.

4. The device according to claim 1, wherein a capacitor is connected between ground and a connection point at which the second bias wiring and each switch are connected; and
said bias circuit comprises:
a first bias potential generating circuit for outputting a steady bias potential as the first bias potential output to cause said first receiver to operate in a steady state; and
a second bias potential generating circuit for outputting a steady bias potential as the second bias potential output to cause said second receivers to operate in a steady state.

5. The device according to claim 1, wherein a circuit is connected to said third bias wiring for outputting a prescribed precharging voltage, as a high bias potential for a prescribed period of time from turn-on of said switches, as the second bias potential output; and
said bias circuit comprises:
a first bias potential generating circuit for outputting a steady bias potential as the first bias potential output to cause said first receiver to operate in a steady state; and
a second bias potential generating circuit for outputting a steady bias potential as the second bias potential output to cause said second receivers to operate in a steady state.

6. A display device comprising the device according to claim 1, wherein said device is used as a data-side driver circuit of the display device.

7. The display device comprising the device according to claim 2, wherein said device is used as a data-side driver circuit of the display device.

8. The display device comprising the device according to claim 3, wherein said device is used as a data-side driver circuit of the display device.

9. The display device comprising the device according to claim 4, wherein said device is used as a data-side driver circuit of the display device.

10. The display device comprising the device according to claim 5, wherein said device is used as a data-side driver circuit of the display device.

11. A display device comprising the device according to claim 1, wherein said display device comprises a liquid crystal display device.

12. A semiconductor integrated circuit device comprising:
a first receiver, to which a clock signal is input in the form of a low-amplitude differential signal, for converting the clock signal to a CMOS signal and outputting the CMOS signal;
a plurality of second receivers, to which data is input in the form of low-amplitude differential signals, for converting the data to CMOS signals and outputting the CMOS signals; and
a bias circuit for supplying bias potentials to said first receiver and to said second receivers to thereby operate said first receiver and said second receivers;
wherein said bias circuit has a first bias potential output to said first receiver and a second bias potential output to each of said second receivers, the first bias potential output is led out by first bias wiring, the second bias potential output is led out by second bias wiring.

13. A semiconductor integrated circuit device comprising:
a first receiver receiving a first clock signal which is a differential signal having a first amplitude, for converting the clock signal to a second signal having a second amplitude which is larger than said first amplitude and outputting the second signal;
a plurality of second receivers each receiving a data signal which is a differential signal having said first amplitude, for converting the data signal to a third signal having said second amplitude and outputting the third signal; and
a bias circuit for supplying bias potentials to said first receiver and to said second receivers to thereby operate said first receiver and said second receivers, said bias circuit having a first bias potential output coupled to said first receiver and a second bias potential output coupled to each of said second receivers, the first bias potential output being led out by a first bias wiring, the second bias potential output being led out by a second bias wiring.
